(19) United States
(12) Patent Application Publication
(10) Pub. No.: US 2003/0081561 A1
(43) Pub. Date: May 1, 2003

(54) System and method for wireless projection

(76) Inventor: Ju-Fang Hsiao, Hsinchu (TW)

Correspondence Address: BRUCE H. TROXELL, SUITE 1404, 5205 LEESBURG PIKE, FALLS CHURCH, VA, 22041, US

(21) Appl. No.: 10/075,232

(22) Filed: Feb. 15, 2002

(30) Foreign Application Priority Data
Oct. 31, 2001 (TW) 90127035

(51) Int. Cl. H04B 7/00

(52) U.S. Cl. 370/310; 370/469

(57) ABSTRACT

A wireless projection system includes at least a wireless projector box and at least one user end computer. The user end computer consists of at least an input module, a first storage module, a coding module, an user datagram protocol transmission module, a first buffer, a first radio receiving/transmission module, and a first processing module. The wireless projector box includes a server end computer and a projector module linking to the server end computer. The server end computer consists of at least a second radio receiving/transmission module, a second buffer, an user datagram protocol receiving module, a decoding module, and a second processing module. Each user end computer may transmit signals to the server send computer in a wireless linking fashion.

### FIELD OF THE INVENTION

The present invention relates to a projection system and its projection method, and particularly a wireless projection system and a projection method thereof.

### BACKGROUND OF THE INVENTION

In the past before projectors were available, people who did presentations or teaching often had to write highlights or notes on a blackboard or whiteboard while conducting the presentation or lecture. Writing speed generally is much slower than speaking. The blackboard or whiteboard also has a limited writing area. As a result, the efficiency of presentation or teaching is difficult to increase. The introduction of projectors has greatly overcome those disadvantages. The projectors utilize optical principles to project contents written on a transparent material to a screen or display panel (with a clearer projection image when projecting on a white screen or display panel). Employing the projectors, efficiency and effectiveness of presentation and teaching can be greatly improved.

In recent years, rapid innovation and development of electronic technology have spawned many new products. For instance, projectors linking to computers are available on the market nowadays. By means of these products, people can prepare and build presentation or teaching materials in electronic files on the computer. When doing presentation or teaching, the computer may be wired and linked to a projector. Then presentation or teaching can be done easily and effectively by operating the computer.

While the projector linking to a computer allows people to do presentation or teaching more easily and effectively, one set of projector can be connected to only one set of computer. When presentation or teaching materials are stored on more than one set of computers, the projector has to be connected to different computers individually and separately for projecting presentation or teaching materials on the screen or display panel. Such arrangements and operations involve a lot of cable connection and disconnection. In the event of cable lengths cannot meet requirements, the computer or projector has to be moved to desired locations for connection. It incurs a lot of inconveniences. There are still rooms for improvement.

### SUMMARY OF THE INVENTION

The primary object of the invention is to provide a wireless projection system and a projection method that allow a plurality of computers to transmit presentation or teaching materials through a radio communication means to a wireless projection device so that presentation or teaching materials stored in the computers can be projected easily on the screen or display panel.

The wireless projection system of the invention includes at least one user end computer and a wireless projector box. The wireless projector box includes a projector module and a server end computer linking the projector module. The projector module may project data to a location desired. Each user end computer can transmit signals to the server end computer through radio communication.

Each user end computer includes at least: an input module for entering data or commands, a first storage module for storing data, a coding module for coding data, an user datagram protocol transmission module for packaging data to a plurality of packets based on an user datagram protocol, a first buffer for temporarily storing data, a first radio receiving/transmission module for emitting or receiving radio signals, and a first processing module which links the input module, first storage module, coding module, user datagram protocol transmission module, first buffer, and first radio receiving/transmission module for receiving and processing signals transferred from the input module, and retrieving data to be coded from the first storage module, and transferring the data to be coded to the coding module to perform data coding, transferring the coded data to the user datagram protocol transmission module to package in packets, and transferring the packet data to the first buffer, and transferring the packet data individually from the first buffer to the first radio receiving/transmission module for emitting individually by radio signals.

The server end computer includes at least: a second radio receiving/transmission module for emitting or receiving radio signals, a second buffer for temporarily storing data, an user datagram protocol receiving module for rearranging packet data based on the user datagram protocol, a decoding module for decoding data, and a second processing module which links the second radio receiving/transmission module, second buffer, user datagram protocol receiving module, decoding module, and the projector module for transferring individually packet data received by the second radio receiving/transmission module to the second buffer, and transferring the packet data from the second buffer to the user datagram protocol receiving module for repackaging in packets, and transferring the packet data to the decoding module for decoding, and transferring the decoded data to the projector module for projection.

The data or commands input from the input module may include setting data required for registering the server end computer or setting data for altering internal setting values of the wireless projector box. The internal setting values of the wireless projector box may include Internet Protocol (IP) address or transmission mode of the wireless projector box. The transmission mode of the wireless projector box may include infrastructure mode or ad hoc mode. Moreover, radio signal transmission between the first radio receiving/transmission module and the second radio receiving/transmission module may include using the ad hoc mode for direct transmission or using the infrastructure mode for indirect transmission through a wireless network access point. In addition, the wireless projection system set forth above may link to at least one external network outside the system through the wireless network access point for transmitting packet data to the network.

The input module may include keyboards, mouse devices, floppy disk drives or optical disk drives. The first storage module and the second storage module may include hard disk drives or non-volatile memory. The first buffer and the second buffer may include volatile memory. The first processing module and the second processing module may include a central processing unit. The projector module may include a liquid crystal display projector. The coding module and the user datagram protocol transmission module may be obtained by directly entering input through the input module to the user end computer, or by radio transmission from the server end computer to the user end computer.

To obtain the coding module and the user datagram protocol transmission module previously discussed, when the server end computer transmits to the user end computer through radio transmission, the server end computer must include a second storage module to couple with the second processing module, and the user end computer must include a Transmission Control Protocol (TCP) transmission module and a TCP receiving module to couple with the first processing module. The second storage module is used for storing data related to the coding module and the user datagram protocol transmission module. The TCP transmission module is used to transform signals to TCP formats for transmitting. The TCP receiving module is used to receive signals of TCP formats and convert to original signals.

The wireless projection method of the invention is based on the wireless projection system set forth above, and includes at least the following steps:

Activating connection between the user end computer and server end computer; transferring data to be coded in the user end computer from the first storage module to the coding module for data coding; transferring the coded data from the coding module to the user datagram protocol transmission module to package in packets; transferring the packet data from the user datagram protocol transmission module to the first buffer for temporarily storing; transferring the packet data individually from the first buffer to the first radio receiving/transmission module for emitting in radio signal formats; utilizing the second radio receiving/transmission module to receive the radio signals emitted from the first radio receiving/transmission module; transferring the packet data received in the second radio receiving/transmission module to the second buffer; transferring the packet data from the second buffer to the user datagram protocol receiving module to repackage the packet data; transferring the repackaged packet data to the decoding module for data decoding; and transferring the decoded data to the projector module for data projection.

The radio signal transmission between the user end computer and server end computer may be directly done by an ad hoc mode transmission or be indirectly done by an infrastructure mode transmission through a wireless network access point. The input module may include keyboards, mouse devices, floppy disk drives or optical disk drives. The first storage module and the second storage module may include hard disk drives or non-volatile memory. The first buffer and the second buffer may include volatile memory. The first processing module and the second processing module may include a central processing unit. The projector module may include a liquid crystal display projector. Moreover, the coding module and the user datagram protocol transmission module may be obtained by directly entering input through the input module to the user end computer, or by radio transmission from the server end computer to the user end computer.

In addition, to obtain the coding module and the user datagram protocol transmission module, when the server end computer transmits to the user end computer through radio transmission, the server end computer must include a second storage module to couple with the second processing module, and the user end computer must include a Transmission Control Protocol (TCP) transmission module and a TCP receiving module to couple with the first processing module. The second storage module is used for storing data related to the coding module and the user datagram protocol transmission module. The TCP transmission module is used to transform signals to TCP formats for transmitting. The TCP receiving module is used to receive signals of TCP formats and convert to original signals.

The method of transmitting data related to the coding module and user datagram protocol transmission module by radio transmission from the server end computer to the user end computer includes the following steps:

Entering loading request signals for the coding module and user datagram protocol transmission module to the user end computer; transforming the loading request signals to TCP formats; directly transferring TCP format signals in an ad hoc transmission mode from the first radio receiving/transmission module to the second radio receiving/transmission module; transferring the TCP format signals to the second processing module; the second processing module, based on the received TCP format signals, retrieves from the second storage module data related to the coding module and user datagram protocol transmission module; transmitting the data related to the coding module and user datagram protocol transmission module in ad hoc transmission mode and by TCP formats from the second radio receiving/transmission module directly to the first radio receiving/transmission module; converting the TCP format signals received in the first radio receiving/transmission module to the original signals; setting up the coding module and user datagram protocol transmission module in the user end computer based on the converted original signals.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an architecture block diagram of a preferred embodiment of the wireless projection system according to the invention.

FIG. 2 is a flow chart of the wireless projection method based on a preferred embodiment of the invention.

FIG. 3 is a flow chart of a method according to a preferred embodiment of the invention, for downloading data related to the coding module and user datagram protocol transmission module from a server end computer to an user end computer.

### DESCRIPTION OF THE PREFERRED EMBODIMENT

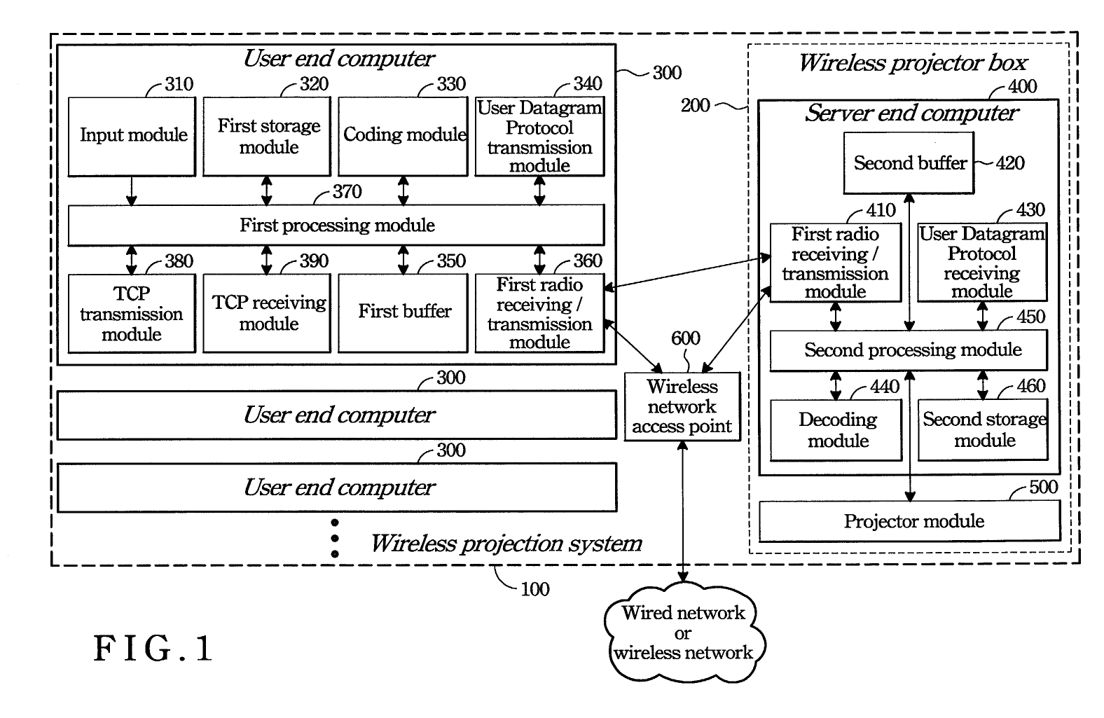

Referring to FIG. 1 for a preferred embodiment of the invention, the wireless projection system 100 includes at least a Wireless Projector Box (WPB) 200 and at least one user end computer 300. Each user end computer 300 consists of at least an input module 310, a first storage module 320, a coding module 330, an User Datagram Protocol (UDP) transmission module 340, a first buffer 350, a first radio receiving/transmission module 360 and a first processing module 370. The Wireless Projector Box 200 includes a server end computer 400 and a projector module 500 linking to the server end computer 400. The server end computer 400 consists of at least a second radio receiving/transmission module 410, a second storage module 420, an UDP receiving module 430, a decoding module 440, and a second processing module 450. The user end computer 300 can transmit signals to or receive signals from the server end computer 400 in a wireless linking fashion.

The input module 310 allows users to enter data or commands. The input data may include setting data required for registering the server end computer 400. The first storage module 320 is for storing data. The coding module 330 is for coding data. The UDP transmission module 340 is for dividing and packaging data in a plurality of packets based on the UDP. The first buffer 350 is for temporarily storing data. The first radio receiving/transmission module 360 is for transmitting or receiving radio signals.

The first processing module 370 connects the input module 310, first storage module 320, coding module 330, UDP transmission module 340, first buffer 350, and first radio receiving/transmission module 360 for receiving and processing signals transferred from the input module 310, and retrieving data to be coded from the first storage module 320 and transferring to the coding module 330 to perform data coding, and transferring the coded data to the UDP transmission module 340 to package in packets, and transferring the packet data to the first buffer 350, and transferring the packet data individually to the first radio receiving/transmission module 360 for emitting by radio signals.

The second radio receiving/transmission module 410 is for transmitting or receiving radio signals. The second buffer 420 is for temporarily storing data. The UDP receiving module 430 is for rearranging packet data based on the UDP. The decoding module 440 is for decoding data. The projector module 500 projects the decoded data to a location desired.

The second processing module 450 connects the second radio receiving/transmission module 410, second buffer 420, UDP receiving module 430, decoding module 440, and projector module 500 for transferring individually packet data received by second radio receiving/transmission module 410 to the second buffer 420, and transferring the packet data from the second buffer 420 to the UDP receiving module 430 for repackaging in packets, and transferring the packet data to the decoding module 440 for decoding, and transferring the decoded data to the projector module 500 for projection.

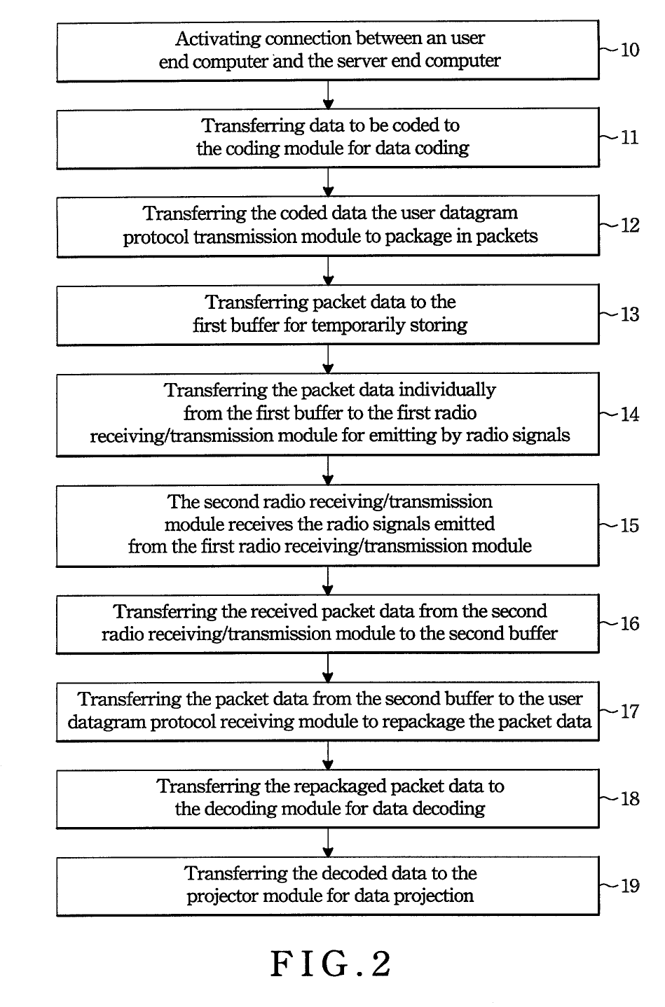

Referring to FIG. 2 for a wireless projection method of an embodiment of the invention, the method may base on the wireless projection system 100 set forth above and include at least the following steps:

First, activating connection between an user end computer and a server end computer (step 10); then transferring data to be coded in the user end computer from the first storage module to the coding module for data coding (step 11); transferring the coded data from the coding module to the UDP transmission module to package in packets (step 12); transferring packet data from the UDP transmission module to the first buffer for temporarily storing (step 13); transferring the packet data individually from the first buffer to the first radio receiving/transmission module for emitting by radio signals (step 14);

then utilizing the second radio receiving/transmission module to receive the radio signals emitted from the first radio receiving/transmission module (step 15); transferring the packet data received in the second radio receiving/transmission module to the second buffer (step 16); transferring the packet data from the second buffer to the UDP receiving module to repackage the packet data (step 17); transferring the repackaged packet data to the decoding module for data decoding (step 18); and transferring the decoded data to the projector module for data projection (step 19.

Referring to FIG. 1 again, in the embodiment and method of the invention, the first radio receiving/transmission module 360 may directly emit radio signals in an ad hoc mode transmission fashion to the second radio receiving/transmission module 410, or indirectly emit in an infrastructure mode transmission fashion through a wireless network access point (AP) 600 to the second radio receiving/transmission module 410. Of course the second radio receiving/transmission module 410 may also emit radio signals in an ad hoc mode transmission fashion or infrastructure mode transmission fashion to the first radio receiving/transmission module 360.

In the event that the first radio receiving/transmission module 360 employs the infrastructure mode transmission to indirectly transmit radio signals through a wireless network access point 600 to the second radio receiving/transmission module 410, the wireless projection system 100 not only can perform wireless projection function, it also can be linked to other wired or wireless networks through the wireless network access point 600 for transmitting other packets not related to the aforesaid wireless projection to the other wired or wireless networks (such as to receive e-mail or download a large amount of data when the presentation is proceeding).

In addition, the wireless projector box 200 set forth above does not have input devices for data entry. It utilizes a network station accessing approach to change internal setting values (such as Internet Protocol (IP) address of the wireless projector box 200, transmission mode (such as infrastructure mode or ad hoc mode), and Service Set Identification (SSID) of the wireless network access point 600). In other words, all settings are altered at the user end through registering the network station, and through calling the Common Gateway Interface (CGI) (which is a standard for communication between the network station server and external programs) to change the setting values in the wireless projector box 200.

In the previous discussions, the coding module 330 and the UDP transmission module 340 may be obtained by directly entering on the input module 310 to input in the user end computer 300, or through the server end computer 400 to transmit in a wireless transmission fashion to the user end computer 300. Referring to FIG. 1, in the event that the coding module 330 and the UDP transmission module 340 are obtained through the server end computer 400 transmitting in a wireless transmission fashion to the user end computer 300, the server end computer 400 must include a second processing module 450 linking to the second storage module 460 for storing data related to the coding module 330 and the UDP transmission module 340, and the user end computer 300 also must includes a TCP transmission module 380 and a TCP receiving module 390 linking to the first processing module 370.

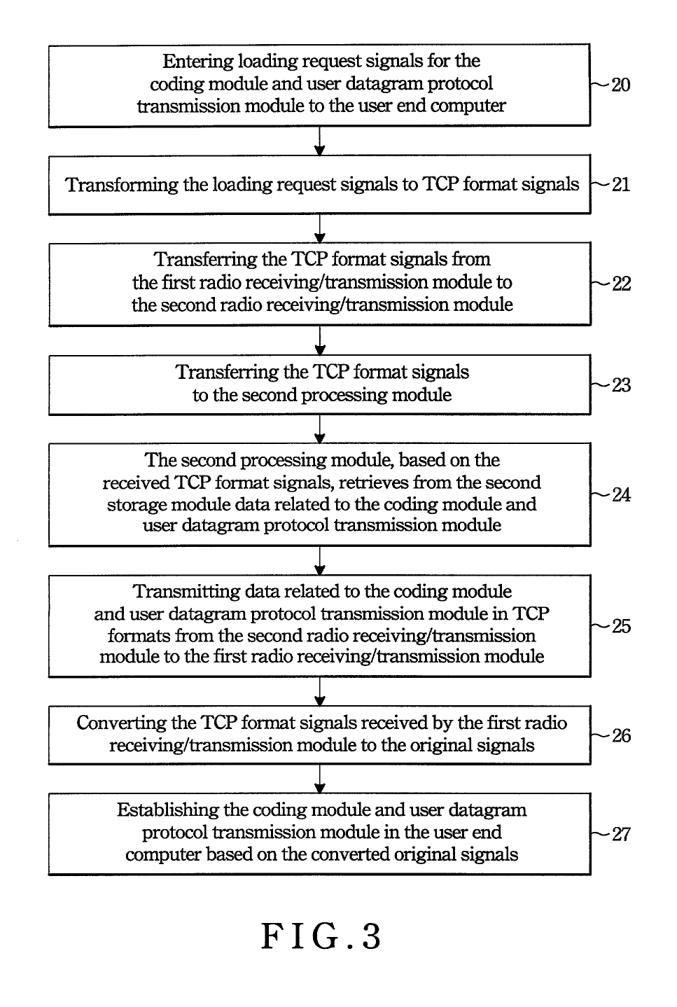

The TCP transmission module 380 transforms signals to TCP formats for emitting. The TCP receiving module 390 receives signals in TCP formats and converts the received signals to original signals. FIG. 3 illustrates a process embodiment for transmitting data related the coding module 330 and UDP transmission module 340 from the server end computer 400 to the user end computer 300. As shown in FIG. 3, the server end computer 400 may download data related the coding module 330 and UDP transmission module 340 to the user end computer 300. The process includes the following steps:

Entering loading request signals for the coding module and UDP transmission module to the user end computer (step 20); transforming the loading request signals for the coding module and UDP transmission module to TCP format signals (step 21); directly transmitting the TCP format signals in an ad hoc mode transmission from the first radio receiving/transmission module to the second radio receiving/transmission module (step 22); transferring the TCP format signals to the second processing module (step 23); the second processing module, based on the received TCP format signals, retrieves from the second storage module data related to the coding module and UDP transmission module (step 24); transmitting in an ad hoc mode transmission data related to the coding module and UDP transmission module in TCP formats from the second radio receiving/transmission module directly to the first radio receiving/transmission module (step 25); converting the TCP format signals received by the first radio receiving/transmission module to the original signals (step 26); setting up coding module and UDP transmission module in the user end computer based on the converted and obtained original signals (step 27).

In the previous discussions, the input module 310 may include keyboards, mouse devices, floppy disk drives or optical disk drives. The first storage module 320 and the second storage module 460 may include hard disk drives or non-volatile memory. The first buffer 350 and the second buffer 420 may include volatile memory. The first processing module 370 and the second processing module 450 may include a central processing unit. The projector module 500 may include a liquid crystal display projector.

While the preferred embodiment of the inventions has been set forth for purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A wireless projection system comprising at least:
at least one user end computer which includes at least:
an input module for entering data or commands;
a first storage module for storing data;
a coding module for coding data;
an user datagram protocol transmission module for dividing and packaging data in a plurality of packets based on an user datagram protocol;
a first buffer for temporarily storing data;
a first radio receiving/transmission module for transmitting or receiving radio signals; and
a first processing module for linking the input module, the first storage module, the coding module, the user datagram protocol transmission module, the first buffer, and the first radio receiving/transmission module for receiving and processing signals transferred from the input module, and retrieving data to be coded from the first storage module and transferring the data to be coded to the coding module to perform data coding, transferring the coded data to the user datagram protocol transmission module to package in packets, and transferring the packet data to the first buffer, and transferring the packet data individually to the first radio receiving/transmission module for emitting by radio signals; and
a wireless projector box including a projector module for projecting data to a location desired and a server end computer linking the projector module for transmitting signal to and receiving signals from the user end computer in a wireless linking fashion, the server end computer including at least:
a second radio receiving/transmission module for transmitting or receiving radio signals;
a second buffer for temporarily storing data;
an user datagram protocol receiving module for rearranging packet data based on the user datagram protocol;
a decoding module for decoding data; and
a second processing module linking the second radio receiving/transmission module, the second buffer, the user datagram protocol receiving module, the decoding module, and the projector module for individually transferring packet data received by the second radio receiving/transmission module to the second buffer, and transferring the packet data from the second buffer to the user datagram protocol receiving module for repackaging in packets, and transferring the packet data to the decoding module for decoding, and transferring the decoded data to the projector module for projection.

2. The wireless projection system of claim 1, wherein the data or the commands entered from the input module include registration data required for setting the server end computer or setting data for altering internal setting values of the wireless projector box.

3. The wireless projection system of claim 2, wherein the internal setting values of the wireless projector box selectively include Internet Transmission Control Protocol address or transmission mode.

4. The wireless projection system of claim 3, wherein the transmission mode of the wireless projector box selectively includes an infrastructure mode or an ad hoc mode.

5. The wireless projection system of claim 1, wherein the radio signal transmission between the first radio receiving/transmission module and the second radio receiving/transmission module includes an ad hoc mode for direct transmission.

6. The wireless projection system of claim 1, wherein the radio signal transmission between the first radio receiving/transmission module and the second radio receiving/transmission module includes an infrastructure mode for indirect transmission through a wireless network access point.

7. The wireless projection system of claim 6, wherein the wireless network access point connects at least one external network for transmitting packet data to the external network.

8. The wireless projection system of claim 1, wherein the input module includes keyboards, mouse devices, floppy disk drives or optical disk drives, the first storage module and the second storage module include hard disk drives or non-volatile memory; the first buffer and the second buffer include volatile memory, the first processing module and the second processing module include a central processing unit, and the projector module includes a liquid crystal display projector.

9. The wireless projection system of claim 1, wherein the coding module and the user datagram protocol transmission module are selectively obtained by direct entering from the input module to the user end computer or by means of radio transmission transmitting from the server end computer to the user end computer.

10. The wireless projection system of claim 9, wherein the coding module and the user datagram protocol transmission module are obtained through radio transmission from the server end computer to the user end computer, the server end computer including the second storage module linking to the second processing module, and the user end computer including the transmission control protocol transmission module and the transmission control protocol receiving module linking to the first processing module, wherein
the second storage module is for storing data related the coding module and the user datagram protocol transmission module;
the transmission control protocol transmission module is for converting signals to transmission control protocol format signals for emitting; and
the transmission control protocol receiving module is for receiving the transmission control protocol format signals and converting to original signals.

11. A wireless projection method built in a wireless projection system which includes at least one wireless projector box and one user end computer, each user end computer including at least an input module, a first storage module, a coding module, an user datagram protocol transmission module, a first buffer, a first radio receiving/transmission module, and a first processing module; the wireless projector box including a server end computer and a projector module linking to the server end computer; the server end computer including at least a second radio receiving/transmission module, a second buffer, an user datagram protocol receiving module, a decoding module, and a second processing module; the user end computer transmitting signals to the server end computer in a wireless linking fashion, the method comprising the steps of:
activating connection between the user end computer and the server end computer;
transferring data to be coded in the user end computer from the first storage module to the coding module for data coding;
transferring the coded data from the coding module to the user datagram protocol transmission module to package in packets;
transferring packet data from the user datagram protocol transmission module to the first buffer for temporarily storing;
transferring the packet data individually from the first buffer to the first radio receiving/transmission module for emitting by radio signals;
utilizing the second radio receiving/transmission module to receive the radio signals emitted from the first radio receiving/transmission module;
transferring the packet data received in the second radio receiving/transmission module to the second buffer;
transferring the packet data from the second buffer to the user datagram protocol receiving module to repackage the packet data;
transferring the repackaged packet data to the decoding module for data decoding; and
transferring the decoded data to the projector module for data projection.

12. The method of claim 11, wherein the radio signal transmission between the first radio receiving/transmission module and the second radio receiving/transmission module includes an ad hoc mode transmission for direct transmission.

13. The method of claim 11, wherein the radio signal transmission between the first radio receiving/transmission module and the second radio receiving/transmission module includes an infrastructure mode transmission for indirect transmission through a wireless network access point.

14. The method of claim 11, wherein the input module includes keyboards, mouse devices, floppy disk drives or optical disk drives, the first storage module and the second storage module include hard disk drives or non-volatile memory, the first buffer and the second buffer include volatile memory, the first processing module and the second processing module include a central processing unit, and the projector module includes a liquid crystal display projector.

15. The method of claim 11, wherein the coding module and the user datagram protocol transmission module are selectively obtained by direct entering from the input module to the user end computer or through a wireless transmission means from the server end computer transmitting to the user end computer.

16. The method of claim 11, wherein the coding module and the user datagram protocol transmission module are obtained through a wireless transmission means from the server end computer transmitting to the user end computer, the server end computer including the second storage module linking to the second processing module, and the user end computer including a transmission control protocol transmission module and a transmission control protocol receiving module linking to the first processing module, wherein
the second storage module is for storing data related the coding module and the user datagram protocol transmission module;
the transmission control protocol transmission module is for converting signals to transmission control protocol format signals for emitting; and
the transmission control protocol receiving module is for receiving the transmission control protocol format signals and converting to original signals.

17. The method of claim 16, wherein the server end computer transmits data related to the coding module and the user datagram, protocol transmission module in a wireless transmission fashion to the user end computer, and includes the following steps:
entering loading request signals for the coding module and the user datagram protocol transmission module to the user end computer;
transforming the loading request signals to transmission control protocol format signals;
transferring directly the transmission control protocol format signals in an ad hoc transmission mode from the first radio receiving/transmission module to the second radio receiving/transmission module;
transferring the transmission control protocol format signals to the second processing module;
retrieving from the second storage module data related to the coding module and the user datagram protocol transmission module by the second processing module based on the received transmission control protocol format signals;
transmitting directly the data related to the coding module and the user datagram, protocol transmission module in an ad hoc transmission mode and at transmission control protocol formats from the second radio receiving/transmission module to the first radio receiving/transmission module;
converting the transmission control protocol format signals received in the first radio receiving/transmission module to original signals; and
establishing the coding module and the user datagram protocol transmission module in the user end computer based on the converted original signals.
